(19) United States
(12) Patent Application Publication
(10) Pub. No.: US 2008/0268199 A1
(43) Pub. Date: Oct. 30, 2008

(54) Means to Assemble Sheet Units

(76) Inventor: Lars Eriksson, Emmaboda (SE)

Correspondence Address: DICKSTEIN SHAPIRO LLP, 1825 EYE STREET NW, Washington, DC, 20006-5403, US

(21) Appl. No.: 12/089,640

(22) PCT Filed: Oct. 3, 2006
(86) PCT No.: PCT/SE2006/001122

§ 371 Date: Apr. 9, 2008

(30) Foreign Application Priority Data
Oct. 11, 2005 (SE) 0502234-8

(51) Int. Cl. B32B 3/06

(52) U.S. Cl. 428/99

(57) ABSTRACT

The invention relates to means to assemble sheet units (1) or the like, such as e.g. boards, wood sheets, MDF-sheets, plastic sheets, glass sheets or the like to a furniture (2), such as e.g. a shelf, an exhibition case, a cabinet, a table, a chair, a shield wall or the like. The sheet units (1) comprise connecting means (3) in the form of female portions (6) and/or male portions (7), which are provided and formed in the material of the sheet unit (1), said female portions (6) are formed such as e.g. recesses (4), openings (11) or grooves (8) and said male portions (7) are formed such as projections (5), whereby the connecting means (3) during the assembling process of the sheet units (1) are insertable to each other for keeping together the sheet units (1) by aid of at least one locking function (21), at the same time as the projection (5) comprises at least one larger part (22), which on at least some place is larger than at least one smaller part (23) of the female portion (6), at the same time as the larger part (22), after insertion into a larger opening portion (24) located in the female portion (6) and makes room for said insertion of the larger part (22), is lockable against the smaller part (23).

The present invention relates to means to assemble sheet units to a furniture, said sheets comprise connecting means provided and formed in the sheet material in the form of female portions and male portions, which during assembly of the sheet units fit into each other, so that the furniture when ready is kept together by the connecting means.

Today on market structures are present of this type, which use different fastening means to construct a furniture to assemble and fix into position different sheet units against each other, such as e.g. nails, screws, mountings, glue or the like, when constructing e.g. a shelf, a table, an exhibition case or other types of furnitures. The fastening means cost money and are often hard to work with and are often constituted by complicated technical solutions difficult to understand and look ugly and require great precision in their pass form. This is a great drawback, when e.g. a glass exhibition case shall be constructed, a glass shelf, display cabinet or other furnitures.

One object of the present invention is to reduce the drawbacks existing with the structures of today by providing a connecting means in the sheet material in the form of a male portion and a female portion, said portions connecting the sheet units when the furniture is assembled and ready. The characterizing features of the invention are stated in the following claims.

Thanks to the invention means has now been provided intended to assemble sheet units in the form of furniture portions, made of e.g. boards, wood sheets, MDF-sheets, plastic sheets, glass sheets or the like for constructing of a furniture, a shelf, a exhibition case, a table or the like in providing the sheet units with connecting means in the form of female and male portions. These are provided and formed in the sheet unit material. The female portions are formed as e.g. recesses, openings or grooves. The male portions are formed as projections. The connecting means of the sheet unit match to each other during the assemble process, so that the sheet units can be assembled to a furniture without using fastening means, such as e.g. nails, screws, fittings glue or the like. According to an embodiment example of the invention the connecting means have rest surfaces with a mainly horizontal extension and guiding surfaces having a mainly vertical extension. When constructing a e.g. a shelf the sheet units are orientated into position in a predetermined position in horizontal- and/or vertical position in relation to each other, so that the ready constructed shelf will be clean and beautiful in its appearance without fittings. In this case the connecting means are created by treatment of the sheet units by aid of e.g. cutting, drilling, sawing, water jet cutting with high pressure, stamping, cut with glass cutter or by cutting in e.g. a CNC-guided treatment machine. When the furniture, e.g. the shelf, is assembled, it has mainly two types of sheet units, namely A: supporting vertical sides in the form of shelf sides and back sides and B: horizontal sides in the form of shelf planes.

According to the invention the female portions and the male portions lock to each other, when assembling the furniture by aid of a locking function, the extensions of the male portions having a greater part, which in any location is larger than a smaller part of the female portions, preferably at openings having a larger opening portion that the larger portion, whereby the larger portion after moving into the female portion locks against the smaller portion, which corresponds to a tapering part in the extension. When the tapering part mainly matches into the smaller portion a better stability is obtained of a ready built furniture especially if the locking function is applied to each sheet unit. The most important advantages of the invention thus are that sheet units can be assembled together to furnitures without using fittings in the form of e.g. nails, screws, glue or the like, which is saving both time and money and gives a clean and elegant design.

The invention is described in more detail below by aid of a preferred embodiment example in view of the accompanying drawings, on which

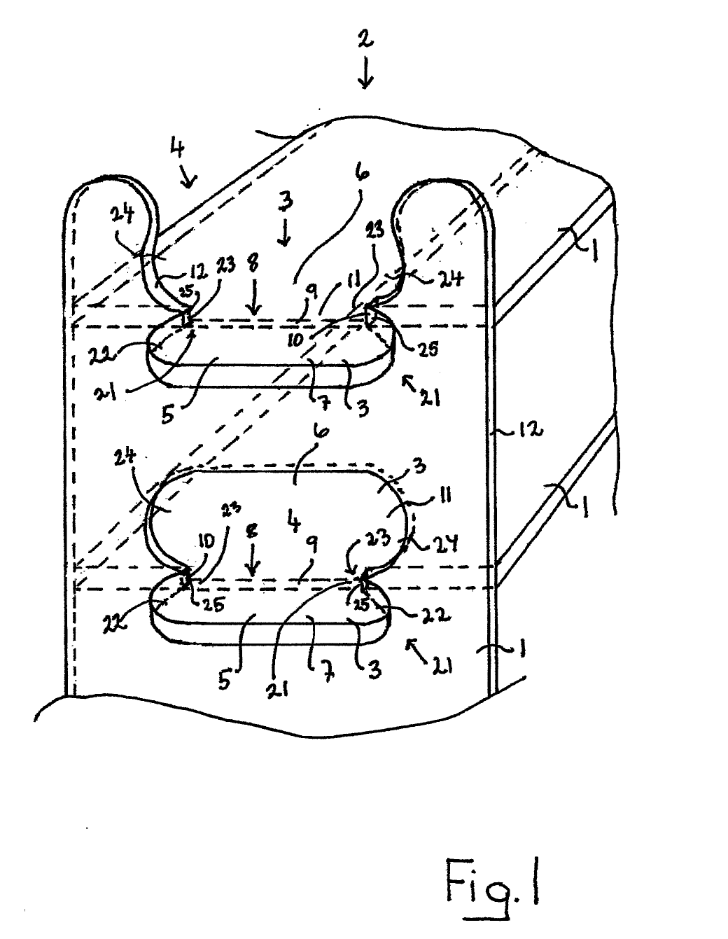

FIG. 1 shows a translucent perspective view of parts of assembled sheet units having a locking function.

As can be seen from FIG. 1 sheet units 1 are illustrated in the form of glass sheets having connecting means 3 in the form of female portions 6 and male portions 7. The female portions 6 are formed as e.g. recesses 4, opening 11 and grooves 8 and the male portions 7 are formed as projections 5. The connecting parts 3 match into each other, so that the sheet units 1, when a furniture 2 is assembled, is kept together by the connecting means 3. The sheet units are resting on resting surfaces 9 with mainly a horizontal extension and is guided by guiding surfaces 10 having mainly a vertical extension. The connecting means 3 are provided next to or consist of the whole or parts of the edges 12 of the sheet unit 1. The female portions 6 and the male portions 7 are locking against each other during constructing the furniture 2 by aid of a locking function 21, at the same time as the projections 5 comprise a larger part 22, which at some place is larger than a smaller part 23 of said female portion 6 at the opening 11. The larger part 22 is inserted into the female portion 6 in a larger opening portion 24. The projections 5 are provided with a tapering part 25, which matches in size into the smaller part 23.

1. Means to assemble sheet units (1) or the like, such as e.g. boards, wood sheets, MDF-sheets, plastic sheets, glass sheets or the like to a furniture (2), such as e.g. a shelf, an exhibition case, a cabinet, a table, a chair, a shield wall or the like, characterized in that the sheet units (1) comprise connecting means (3) in the form of female portions (6) and/or male portions (7), which are provided and formed in the material of the sheet unit (1), said female portions (6) are formed such as e.g. recesses (4), openings (11) or grooves (8) and said male portions (7) are formed such as projections (5), whereby the connecting means (3) during the assembling process of the sheet units (1) are insertable into each other for keeping together the sheet units (1) by aid of at least one locking function (21), at the same time as the projection (5) comprises at least one larger part (22), which on at least some place is larger than at least one smaller part (23) of the female portion (6), at the same time as the larger part (22), after insertion into a larger opening portion (24) located in the female portion (6) and makes room for said insertion of the larger part (22), is lockable against the smaller part (23).

2. Means according to claim 1, characterized in that at least one tapering part (25) in the projection (5) mainly matches in size to be provided into the smaller part (23) preferably at least at an opening (11) located in that place, when the larger part (22) locks against the smaller part (23).

3. Means according to claim 2, characterized in that the connecting parts (3) comprise resting surfaces (9) with mainly a horizontal extension and guiding surfaces (10) having mainly a vertical extension, which during the assembling process orientates the sheet units in a predetermined position in relation to each other, when the tapering part (25) is provided in the smaller part (23).

4. Means according to claim 1, characterized in that the male portions (7) and/or the female portions (6) are provided next to and/or consist of whole or parts of the edges (12) of the sheet units (1), such as e.g. at the ends, elongated sides or surface of the sheet unit (1).
